(19) United States
(12) Patent Application Publication
(10) Pub. No.: US 2022/0403935 A1
(43) Pub. Date: Dec. 22, 2022

(54) SEAL ASSEMBLY AND SEAL ELEMENT

(71) Applicant: Carl Freudenberg KG, Weinheim (DE)

(72) Inventors: Frank Lauer, Rauenberg (DE); Olaf Nahrwold, Ludwigshafen (DE); Boris Traber, Hirschberg (DE); Thomas Kramer, Rimbach (DE); Stefan Sindlinger, Weinheim (DE); Rainer Kreiselmaier, Ludwigshafen (DE); Christoph Naumann, Viernheim (DE); Guido Hohmann, Weinheim (DE)

(21) Appl. No.: 17/777,628

(22) PCT Filed: Oct. 19, 2020
(86) PCT No.: PCT/EP2020/079321

§ 371 Date: May 18, 2022

(30) Foreign Application Priority Data
Nov. 20, 2019 (DE) 10 2019 131 267.1

(51) Int. Cl. F16J 15/3296

(52) U.S. Cl. CPC F16J 15/3296

(57) ABSTRACT

A sealing assembly includes: a first machine element and a second machine element, which delimit a gap; and a sealing element arranged in the gap, the sealing element sealingly laying against the second machine element under an elastic bias, the sealing element having a first section and a second section, the first section coming into contact with a medium to be sealed off. The sealing element includes at least one sensor, the at least one sensor detecting a contact pressure exerted by the sealing element. The at least one sensor is associated with the second section.

### CROSS-REFERENCE TO PRIOR APPLICATIONS

This application is a U.S. National Phase application under 35 U.S.C. § 371 of International Application No. PCT/EP2020/079321, filed on Oct. 19, 2020, and claims benefit to German Patent Application No. DE 10 2019 131 267.1, filed on Nov. 20, 2019. The International Application was published in German on May 27, 2021 as WO2021/099044 under PCT Article 21(2).

### FIELD

The invention relates to a sealing assembly, comprising a first machine element and a second machine element, which delimit a gap, wherein a sealing element is arranged in the gap, wherein the sealing element sealingly lies against the second machine element under an elastic bias, wherein the sealing element has a first section and a second section, wherein the first section comes into contact with the medium to be sealed off.

### BACKGROUND

Seals, in particularly dynamically loaded seals, experience wear during their predetermined service lives, wherein various wear phenomena can be observed. Material fatigue causes the contact stress of the seal to be reduced, the contact pressure is also reduced. Wear, material fatigue and relaxation behavior change the dimensions of the seal so that the contact stress and the contact pressure are gradually reduced. These processes first cause leakage and subsequently failure of the sealing system.

To monitor for the potential leakage of seals, it has been known to integrate a means for leakage monitoring within the seal. Such leakage monitoring is known, for example, from DE 10 2007 007 405 B4. It describes an electrical means for detecting the wear state of a dynamic sealing element. The sealing element comprises an electrically conductive section and an electrically non-conductive section, which is in contact with the machine element to be sealed. The machine element is also electrically conductive. Wear of the sealing element causes the electrically non-conductive sealing material to wear off so that the electrically conductive sealing material eventually comes into contact with the machine element. This closes an electric circuit which can be sensed in turn and thus signals that exchanging of the sealing element is necessary.

This embodiment has a drawback in that gradual changes in state cannot be detected. The only thing that can be detected is that the wear limit of the sealing element has been reached and that the sealing element must be exchanged. Furthermore, this embodiment only detects wear by material removal. However, any loss of sealing action due to relaxation behavior cannot be detected.

### SUMMARY OF THE INVENTION

In an embodiment, the present invention provides a sealing assembly, comprising: a first machine element and a second machine element, which delimit a gap; and a sealing element arranged in the gap, the sealing element sealingly laying against the second machine element under an elastic bias, the sealing element having a first section and a second section, the first section being configured to come into contact with a medium to be sealed off, wherein the sealing element comprises at least one sensor, the at least one sensor being configured to detect a contact pressure exerted by the sealing element, and wherein the at least one sensor is associated with the second section.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a sealing assembly with a sensor in the region of the groove bottom;

FIG. 2 schematically shows a sealing assembly with a sensor received in the passage;

FIG. 3 schematically shows a sealing assembly with the sensor embedded in the sealing element;

FIG. 4 schematically shows a sealing assembly with a multi-part sensor; and

FIG. 5 schematically shows a sealing assembly with an electromechanical sensor formed of the material of the sealing element.

### DETAILED DESCRIPTION

In an embodiment, the present invention provides a sealing assembly having the possibility of permanent and predictive state monitoring of the sealing function of the sealing element, which also considers wear and relaxation behavior.

In an embodiment, the present invention provides a sealing assembly comprising a first machine element and a second machine element, which delimit a gap, wherein a sealing element is arranged in the gap, wherein the sealing element sealingly lies against the second machine element under an elastic bias, wherein the sealing element has a first section and a second section, wherein the first section comes into contact with a medium to be sealed off, wherein the sealing element has at least one sensor associated with it, which detects the contact pressure exerted by the sealing element, wherein the sensor is associated with the second section.

The sealing action of the sealing element essentially results from the contact pressure exerted on the second machine element by the sealing element. The contact pressure exerted by the sealing element, in a sealing element made of an elastomeric material, is caused by the elastic deformation of the sealing material. The elastic deformation generates counteracting forces acting on all contact surfaces of the sealing element, i. e., both on the second machine element to be sealed and on the delimiting wall surfaces of the receiving space of the first machine element. Ageing or changes in dimension, for example caused by wear, cause the elastic bias of the sealing element acting on the contact surfaces to be reduced, which ultimately causes the sealing action to deteriorate. The sensor associated with the sealing element can detect the counteracting force resulting from the elastic deformation. As soon as the contact pressure of the sealing element as detected by the sensor falls below a threshold value, a necessary exchange of the sealing element can be signaled. Herein, the threshold value can be set in such a manner that a noticeable leakage has not yet occurred in the sealing assembly.

The sealing material of the sealing element, mostly an elastomer, is essentially incompressible and thus behaves like a liquid on deformation. Deformation or compression in a certain region causes the material to be displaced. As a result, the contact pressure of the sealing element against the groove side walls increases at the contact positions of the sealing element, for example in a groove. A correctly installed sealing element thus exerts a predetermined contact pressure on the adjacent side walls of the machine elements. Wear causes the contact pressure to gradually lessen. Due to the above-described behavior, the contact pressure not only lessens on opposing side walls but also on all adjacent side walls. The sensor is thus able to detect wear of a sealing element also in the regions of the sealing element having no direct sealing function. The sensor can also detect gradual changes and thus enables continuous monitoring of the sealing assembly.

The pressure detected by the sensor can also be used to determine the contact pressure exerted by the sealing element on the second machine element. Depending on the configuration of the sealing assembly, the contact pressure of the sealing element on the second machine element is directly proportional to the pressure detected by the sensor. Alternatively, it is also conceivable to establish a relation by simulation or the like so that it is possible to derive the contact pressure of the sealing element on the second machine element also in the case of complex designs of the receiving space and/or the sealing element. The sensor can thus be formed as a pressure sensor or as a force sensor.

The second section preferably forms a functional section facing away from the medium to be sealed off. For example, the second section can form a supporting section.

The second section, unlike the first section, has no sealing function. The sensor, which is associated with the second section according to the invention, is associated with a region of the sealing element having no sealing function. The sealing region of the sealing element can thus comprise a sealing material optimally adapted to the sealing function. Furthermore, the sensor is not subject to any direct wear and can be optimized regarding its sensing function. Furthermore, the sensor is not necessarily in contact with media to be sealed off so that the resistance against media is of lesser importance for the choice of sensor.

A receiving space for receiving the sealing element can be arranged in the first machine element. In the case of the machine element having a cylindrical bore, the receiving space can have the shape of a circumferential groove provided in the sidewall of the cylindrical bore.

The sensor is preferably disposed in such a manner that it does not come into contact with the medium to be sealed off. For this purpose, the sensor can be preferably arranged in the receiving space so that the sealing element is disposed between the medium to be sealed off and the sensor. In this embodiment, it is particularly advantageous that the sensor is not subject to any direct wear and that the sensor does not have to fulfil any requirements regarding media resistance, or in the case of food applications, compatibility with foodstuffs. Furthermore, the sensor is preferably associated with a section of the sealing element having no sealing function.

Preferably, the sensor has an electromechanical functioning principle. Such sensors are, for example, piezoresistive sensors, piezoelectric sensors or strain gauges. Such sensors are simple and rugged. The pressure to be detected can also be detected by simple means. Furthermore, continuous monitoring of the sealing assembly is possible. In principle, it is also conceivable for the sensor to have an optomechanical functioning principle.

The sensor can have a multi-part configuration and can comprise at least one spring element and at least one sensor element. The spring element forms a transmission element which transmits the contact pressure exerted by the sealing element to the spring element which is ultimately detected by the sensor element. Depending on the design of the sensor, the spring element can also form a transducer which is changed by a pressure exerted on the spring element so that it experiences a change in length which, in turn, is detected by the sensor. The detection of the sealing state is indirectly carried out via the spring element. In this embodiment, it is also possible for the sensor element to be arranged in a spaced relationship to the sealing element.

The receiving space can be formed as a groove, wherein the sensor is preferably associated with the bottom of the groove. In this embodiment, the sealing element is arranged between the sensor and the space to be sealed off so that the sealing element encapsulates the sensor. This protects the sensor against external influences.

A passage, which is associated with the sensor, can be arranged in the first machine element. According to a first embodiment, the passage accommodates a signal line to connect the sensor to an evaluating unit. This enables the sensor to be particularly easily connected, in particular, it is not necessary to supply the sensor with auxiliary energy. According to a further embodiment, the passage at least partially receives the sensor. This is advantageous, in particular, when the sensor has larger dimensions.

The sensor can be at least partially embedded within the sealing element. In this embodiment, it is not necessary to separately install the sensor. Furthermore, the sensor is protected against external influences by the sealing element.

According to an advantageous embodiment, the sensor can be of the material of the sealing element. Herein, the material according to a first embodiment can be formed as a piezoelectric material. To do this, a piezoelectric filler can be incorporated within the sealing material of the sealing element, which imparts piezoelectric properties to the sealing element. Alternatively, the material of the sealing element can have an electrical resistance which changes as a function of mechanical stress. This property can also be realized by appropriately choosing a suitable filler material.

The sensor can also be attached to the sealing element. This ensures that the sensor is correctly positioned with respect to the sealing element. The sensor is preferably adhesively/weldingly attached by means of adhesive gluing, welding or vulcanization.

The sealing assembly can be a rod seal and/or a valve-seat seal. Particularly preferably, the sealing assembly according to the invention is used in the context of food applications. In food applications, continuous monitoring of the sealing assembly is often necessary to prevent contamination of foodstuffs. The sealing element can then be, for example, an O-ring, a quad-ring or the like. The sealing assembly can also be a static seal.

The sealing element according to the invention for the sealing assembly comprises a sealing body of a sealing material and at least one sensor. Herein, according to a first embodiment, the sensor can be attached to the sealing element or, according to a second embodiment, can be at least partially embedded within the sealing element.

The figures show a sealing assembly 1 having a first machine element 2 and a second machine element 3, which delimit a gap 4. In the present embodiment, the first machine element 2 is a housing and the second machine element 3 is a rod which performs a translatory movement relative to the first machine element 2.

In an alternative embodiment, the sealing assembly 1 is arranged in a valve-seat seal. In this embodiment, the first machine element 2 is a housing and the second machine element 3 is a valve stem.

A sealing element 5 is arranged in the gap 4. Herein, the sealing element 5 separates the space to be sealed off with respect to the environment. In the space to be sealed off, there is a medium to be sealed off, for example lubricating oil. In principle, other embodiments of sealing assemblies with alternative configurations of first machine element 2, second machine element 3 and sealing element 5 are also conceivable.

To receive the sealing element 5, a receiving space 6 is provided in the first machine element 2. In the present case, the receiving space 6 is formed as a groove and has two groove side walls as well as a groove bottom. The receiving space 6 has an annular configuration. The sealing element 5 is inserted in the receiving space 6 and sealingly lies against the second machine element 3 under an elastic bias. In a sealing assembly 1 having an alternative configuration, the sealing element 5 is directly arranged within the gap 4.

In the present case, the sealing element 5 is a seal having a rectangular configuration. Alternatively, the sealing element 5 can be formed as an O-ring or as a quad-ring. The sealing element 5 is formed of an elastomeric sealing material, such as silicone rubber or fluorine rubber.

The sealing element 5 has a sensor 7 associated with it, which detects the contact pressure of the sealing element. After installation, the sealing element 5 sealingly lies against the second machine element 3 under an elastic bias. This urges the sealing element 5 into the receiving space 6 and exerts a force on the sensor 7. As wear progresses, the contact pressure of the sealing element 5 on the second machine element 3 to be sealed lessens, thus also lessening the force exerted by the sealing element 5 on the sensor 7. This enables the sensor 7 to continuously determine the contact pressure of the sealing element 5 and thus the wear of the sealing element 5. When the contact pressure of the sealing element 5 on the sensor 7 falls below a predetermined value, the necessity to exchange the sealing element 5 can be signaled.

The sensor 7 has an electromechanical functioning principle so that the pressure is detectable by simple means and can be electronically passed on to an evaluating unit.

The sealing element 5 comprises a first section 13 facing the second machine element 3 and a second section 14 facing away from the second machine element 3. The sensor 7 is associated with the second section 14 and is thus spaced from the second machine element 3.

In the present embodiment, the first section 13 is formed as a sealing section and the second section 14 is formed as a supporting section.

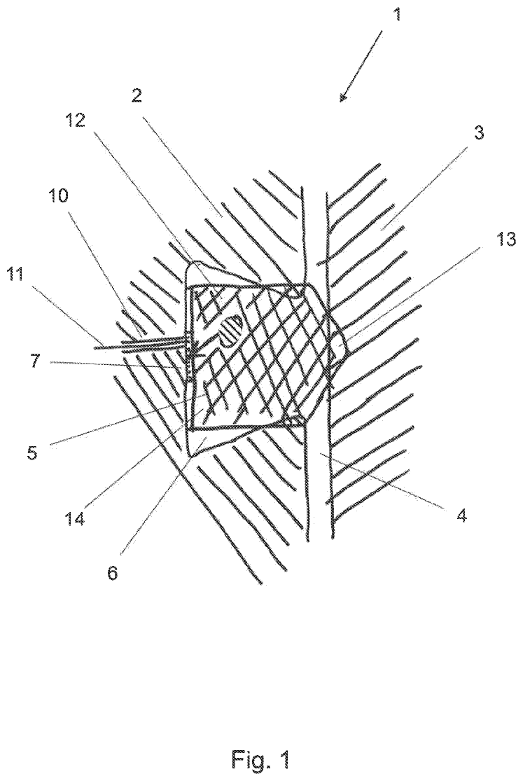

FIG. 1 shows a first embodiment of the sealing assembly 1. In the present embodiment, the sensor 7 is attached to the sealing element 5. After installation, the sensor 7 is in the receiving space 6 between the sealing element 5 and the groove bottom of the receiving space 6.

A passage 10 opens out into the receiving space, which receives a signal line for connecting the sensor 7 to an evaluating unit.

In the present case, the sensor 7 is attached to the sealing element 5. Alternatively, the sensor 5 can be inserted in the receiving space 6 and can be retained exclusively by the contact pressure of the sealing element 5. In a further alternative embodiment, the sensor 7 can be fixed in the receiving space 6 by means of a screw connection.

The sensor 7 can be formed as a strain gauge arranged on the side of the sealing element 5 associated with the groove bottom of the receiving space 6. According to another alternative embodiment, the sensor 7 can be formed as a piezoresistive sensor.

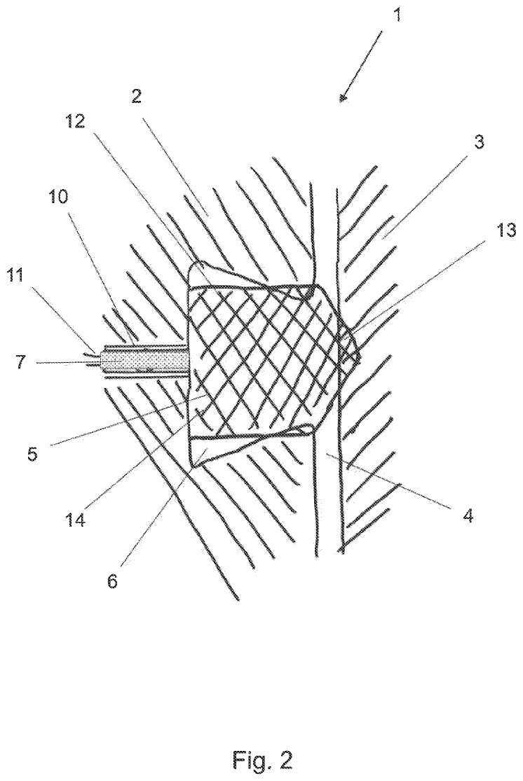

FIG. 2 shows a further development of the sealing assembly 1 shown in FIG. 1. In the present embodiment, the passage receives the signal line as well as the sensor 7. At the opening of the passage into the receiving space 6, the sensor 7 lies against the sealing element 5.

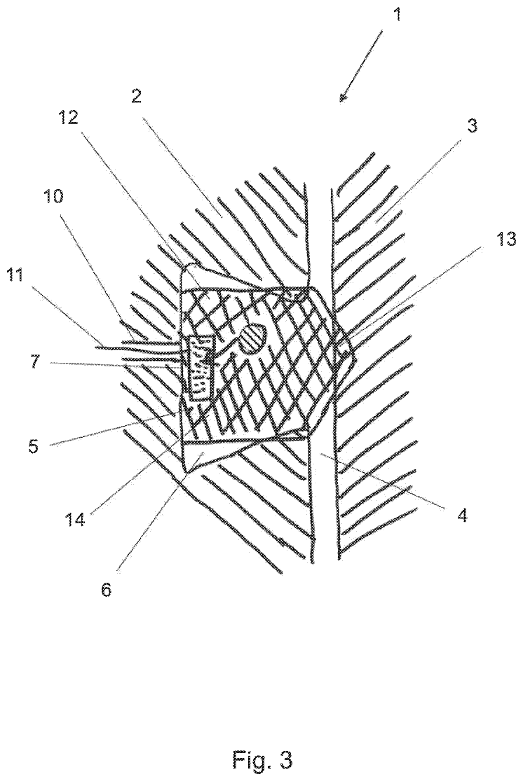

In the embodiment according to FIG. 3, sensor 7 is embedded in the sealing element 5. For manufacture, the sensor 7 is placed in a molding die and embedded in sealing material by injection molding. In this embodiment, the sensor 7 is encapsulated within the sealing element 5. A passage 10 opens out into the receiving space 6, which receives the signal line 11 for connecting the sensor 7 to an evaluating unit.

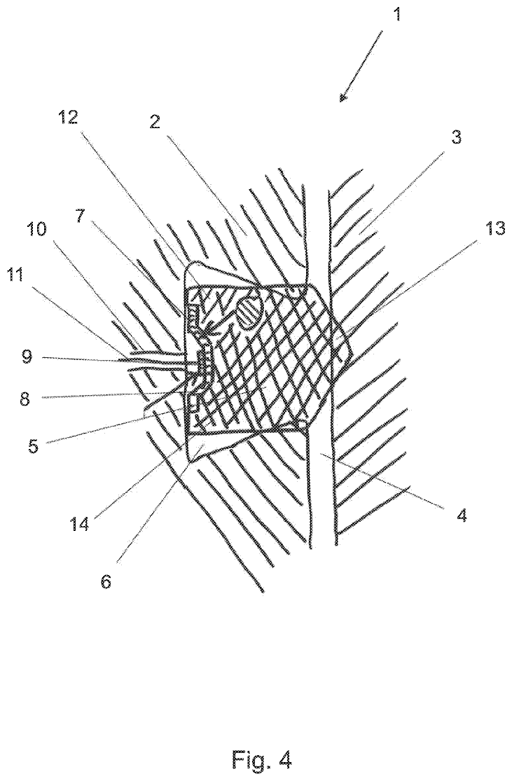

FIG. 4 shows a sealing assembly 1 in which a spring element 8 is associated with the sealing element 5 on the side facing the groove bottom of the receiving space 6. The spring element 8 has a configuration similar to a diaphragm spring. On the side of the spring element 8 facing away from the sealing element 5, a sensor element 9 is arranged. Spring element 8 and sensor element 9, in this embodiment, form a sensor 7 in the form of a pressure sensor. The sensor element 9 detects deformations of the spring element 8 resulting from the sealing element 5 exerting a contact pressure. A passage 10 opens out into the receiving space 6, which receives the signal line 11 for connecting the sensor 7 to an evaluating unit.

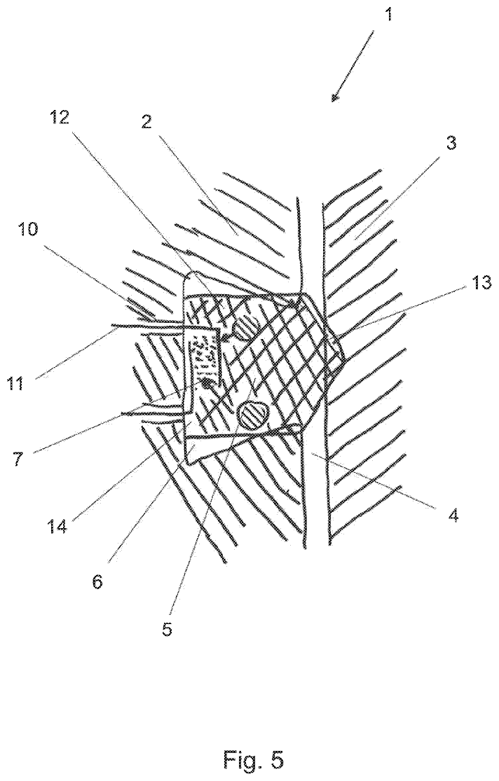

FIG. 5 shows a sealing assembly 1 in which the sensor 7 is formed of the material of the sealing element 5, i. e., of the sealing material. To achieve this, filling materials are introduced into the material, which impart electromechanical properties to the material. Herein, the filling material can be introduced into the material in such a manner that the electromechanical properties are only created locally, for example on the side facing the groove bottom of the receiving space 6.

According to an advantageous embodiment, the side of the sealing element 5 facing away from the second machine element 3 is formed as a piezoelectric pressure sensor so that the sensor 7 is formed of the same material and integral with the sealing element 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A,

1. A sealing assembly, comprising:
a first machine element and a second machine element, which delimit a gap; and
a sealing element arranged in the gap, the sealing element sealingly laying against the second machine element under an elastic bias, the sealing element having a first section and a second section, the first section being configured to come into contact with a medium to be sealed off,
wherein the sealing element comprises at least one sensor, the at least one sensor being configured to detect a contact pressure exerted by the sealing element, and
wherein the at least one sensor is associated with the second section.

2. The sealing assembly of claim 1, wherein the second section comprising a functional section facing away from the medium to be sealed off.

3. The sealing assembly of claim 1, wherein the second section comprises a supporting section.

4. The sealing assembly of claim 1, wherein the at least one sensor comprises an electromechanical functioning sensor.

5. The sealing assembly of claim 1, wherein the at least one sensor comprises at least one spring element and at least one sensor element.

6. The sealing assembly of claim 1, wherein, a receiving space is arranged in the first machine element, the receiving space being configured to receive the sealing element.

7. The sealing assembly of claim 6, wherein the receiving space comprises a groove and the at least one sensor is associated with a bottom of the groove.

8. The sealing assembly of claim 1, wherein a passage is arranged in the first machine element, the passage being associated with the sealing element.

9. The sealing assembly of claim 8, wherein the passage at least partially receives the at least one sensor and/or a signal line for connecting the at least one sensor.

10. The sealing assembly of any claim 1, wherein the at least one sensor is attached to the sealing element.

11. The sealing assembly of claim 1, wherein the at least one sensor is at least partially embedded in the sealing element.

12. The sealing assembly of claim 1, wherein the at least one sensor comprises a material of the sealing element.

13. The sealing assembly of claim 12, wherein the material of the sealing element comprises a piezoelectric material.

14. The sealing assembly of claim 13, wherein the material of the sealing element has an electrical resistance which changes as a function of mechanical stress.

15. A sealing element for the sealing assembly of claim 1, comprising:
a sealing body of a sealing material; and
the at least one sensor.
